(19) United States
(12) Patent Application Publication
(10) Pub. No.: US 2015/0128795 A1
(43) Pub. Date: May 14, 2015

(54) ROTATING MECHANISM

(71) Applicants: SHENZHEN FUTAIHONG PRECISION INDUSTRY CO., LTD., Shenzhen (CN); FIH (HONG KONG) LIMITED, Kowloon (HK)

(72) Inventors: YONG-FU HU, Shenzhen (CN); BING YU, Shenzhen (CN); JIAN-PING JIN, Shenzhen (CN)

(21) Appl. No.: 14/533,253

(22) Filed: Nov. 5, 2014

(30) Foreign Application Priority Data
Nov. 12, 2013 (CN) 201310559134.2

(51) Int. Cl. F15B 15/12; B65C 9/36; F15B 15/20

(52) U.S. Cl. CPC F15B 15/125; F15B 15/202; B65C 9/36
USPC 91/462

(57) ABSTRACT

A rotating mechanism includes a holder assembly, a rotating assembly, and a valve assembly. The holder assembly includes a mounting block. The rotating assembly includes a shaft and a rotating block. The shaft is mounted to the holder assembly. The rotating block is sleeved on the shaft and is mounted to the mounting block. The valve assembly communicates with the mounting block so that gas is capable of coming in to the mounting block to drive the rotating block to rotate and make the shaft rotate.

### CROSS-REFERENCE TO RELATED APPLICATIONS

This application claims priority to Chinese Patent Application No. 201310559134.2 filed on Nov. 12, 2013, the contents of which are incorporated by reference herein.

### FIELD

The disclosure generally relates to rotating mechanisms, and particularly relates to a rotating mechanism for adjusting positions of tags on a product.

### BACKGROUND

Products need to be pasted with tags after manufactured for being identified. A tags pasting device is configured to paste the tags on the products. Generally, the tags cannot be pasted on an exact position because of some errors and operators need to manually adjust the tags to an exact position at the moment.

### BRIEF DESCRIPTION OF THE DRAWINGS

Implementations of the present technology will now be described, by way of example only, with reference to the attached figures.

FIG. 1 is an exploded, isometric view of an embodiment of a rotating mechanism.

FIG. 2 is an assembled view of a holder assembly and a rotating assembly of the rotating mechanism of FIG. 1.

FIG. 3 is an exploded, isometric view of a valve assembly of the rotating mechanism of FIG. 1.

FIG. 4 is an assembled view of the rotating mechanism of FIG. 1.

FIG. 5 is an isometric view of an operating state of the rotating mechanism of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

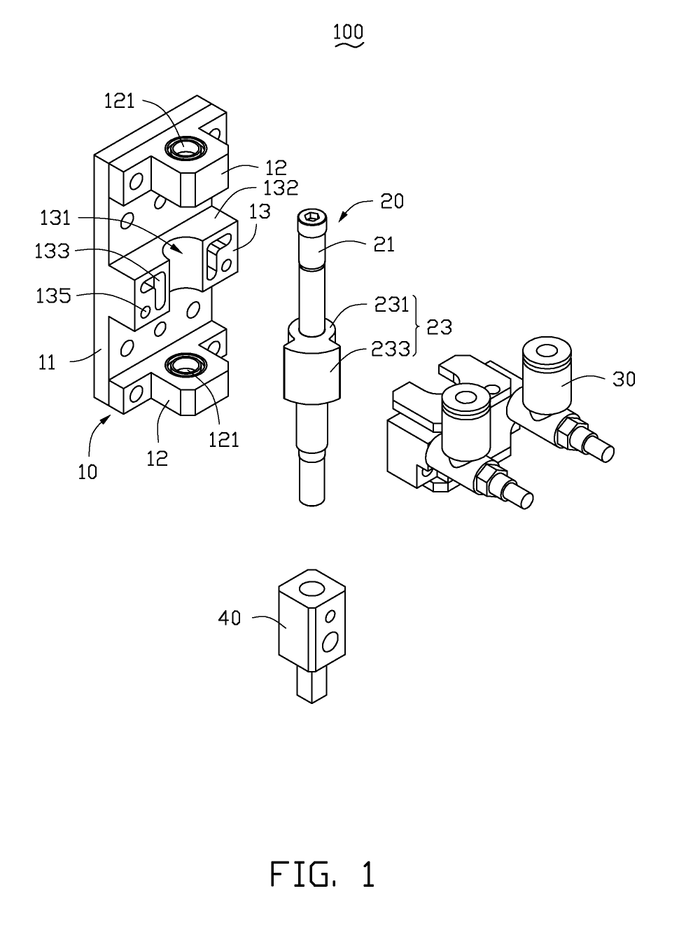

FIG. 1 illustrates an embodiment of a rotating mechanism 100. The rotating mechanism 100 is configured to adjust positions of tags on a product. The rotating mechanism 100 includes a holder assembly 10, a rotating assembly 20, a valve assembly 30, and an absorber 40. The holder assembly 10 is mounted to a tags pasting device (not shown). The rotating assembly 20 is mounted to the holder assembly 10 and is used to adjust positions of the tags on the product. The valve assembly 30 is mounted on the holder assembly 10 and is configured to drive the rotating assembly 20 to rotate. The absorber 40 is mounted to an end of the rotating assembly 20 and is configured to absorb the tags.

As illustrated, the holder assembly 10 includes a base board 11, two guiding blocks 12, and a mounting block 13. The base board 11 is substantially rectangular and is mounted to the tags pasting device. The two guiding blocks 12 can be positioned at two opposite ends of the base board 11 via crews (not shown). Each guiding block 12 defines a guiding hole 121. In this embodiment, the guiding hole 121 is defined at a longitudinal direction of the guiding block 12. The guiding hole 121 is configured to guide the rotating assembly 20 to be mounted to the holder assembly 10.

The mounting block 13 is mounted to a middle of the base board 11 and is located between the two guiding blocks 11. The mounting block 13 defines a mounting slot 131. In this embodiment, the mounting slot 131 is substantially U-shaped and is defined at a middle of the mounting block 13. The mounting slot 131 divides the mounting block 13 into two mounting portions 132. Each mounting portion 132 defines a gas slot 133 and a mounting hole 135. In this embodiment, the gas slot 133 is substantially L-shaped.

The rotating assembly 20 includes a shaft 21 and a rotating block 23. Two ends of the shaft 21 are respectively inserted through a guiding hole 121 of the guiding block 12. The rotating block 23 includes a coupling portion 231 and a rotating portion 233. The coupling portion 231 is sleeved on the shaft 21. The rotating portion 23 protrudes from a periphery wall of the coupling portion 231. In this embodiment, the rotating portion 23 is substantially fan-shaped and can rotate under a control of a gas.

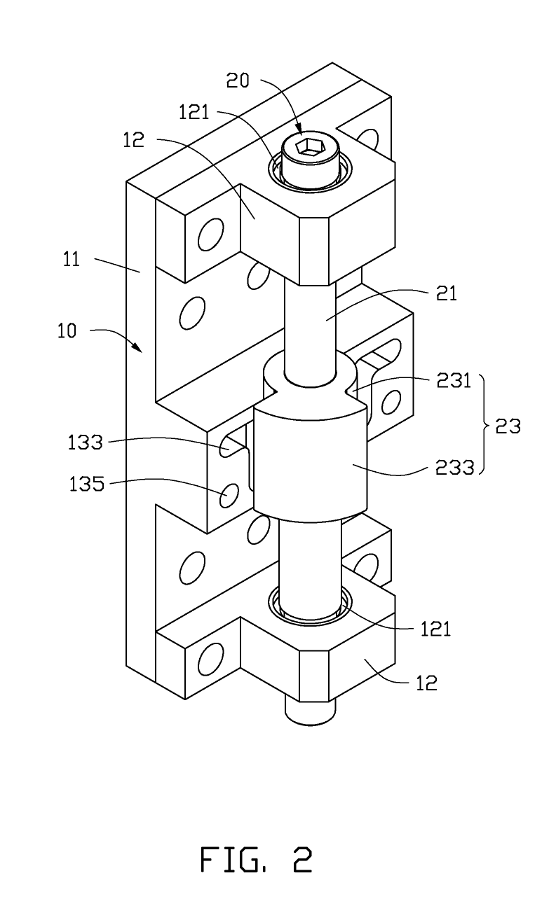

FIG. 2 illustrates that when the rotating assembly 20 is mounted to the holder assembly 10, two ends of the shaft 21 respectively passes through the guiding hole 121 of the guiding block 12. The coupling portion 231 is received in the mounting slot 131 of the mounting block 13. The rotating portion 233 is located at one of the two gas slots 133.

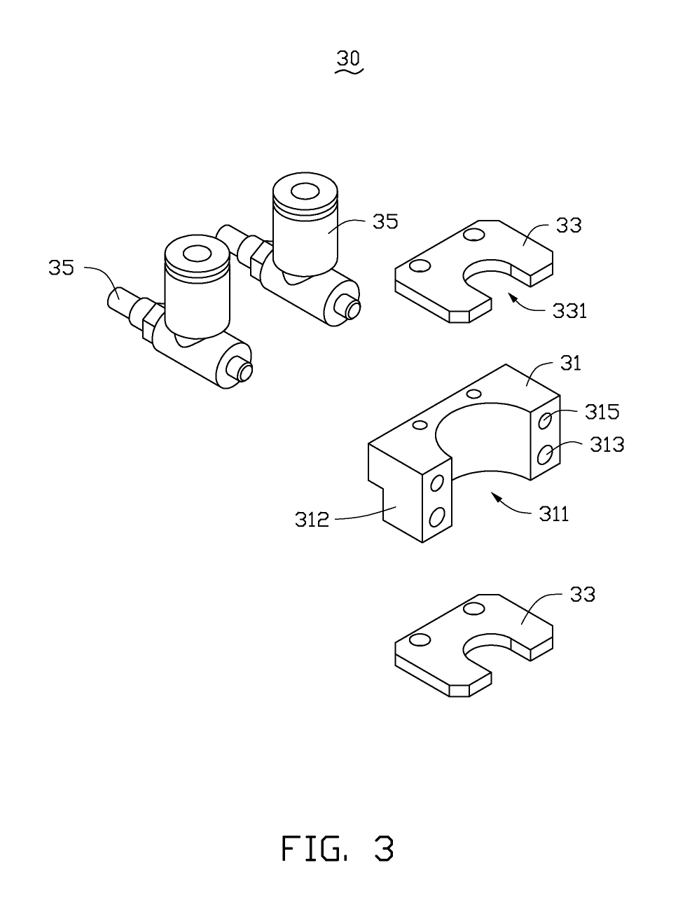

FIG. 3 illustrates that the valve assembly 30 includes a main body 31, two coupling boards 33, and two gas valves 35. The main body 131 is coupled to the mounting block 13 to mount the valve assembly 30 to the mounting block 13. The main body 31 defines a rotating slot 311. The rotating slot 311 cooperates with the mounting slot 131 to receive the rotating portion 233 of the rotating assembly 23 and the rotating portion 233 can rotate along a surface of the rotating slot 311. The rotating slot 311 divides the main body 31 into two latching portion 312. Each latching portion 312 defines a latching hole 313 and a gas hole 315. In this embodiment, the latching hole 313 is configured to cooperate with the mounting hole 135 so as to mount the valve assembly 30 to the main body 31.

The two coupling boards 33 are positioned at two sides of the main body 31. Each coupling board 33 defines an opening 331. In this embodiment, the opening 331 is substantially U-shaped. The two gas valves 35 are mounted on another side of the main body 31 and spaced from each other. The two gas valves 35 are communicated with the two gas hole 315 via internal channels (not shown). The two gas valves 35 can be respectively coupled to a gas pipe for driving the rotating assembly 20 to rotate. In detail, when one of the two gas valves 35 is opened, the gas can be transmitted to a corresponding gas slot 133 via the opened gas valve 35 and the gas hole 315, then travels to the other gas slot 133, and emerges there to force the rotating portion 233 rotate along a surface of the rotating slot 311 toward the other gas slot 133 that receives the gas.

The absorber 40 is mounted to an end of the shaft 21. The absorber 40 may couple to an external gas pipe (not shown). The external gas pipe provides suction power to the absorber 40 to absorb tags.

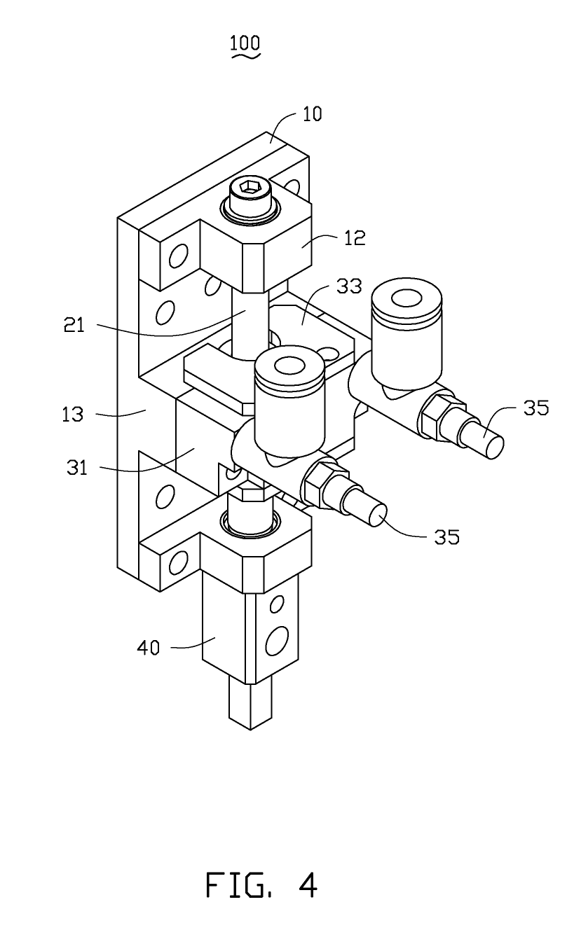

FIG. 4 illustrates an assembled view of the rotating mechanism 100. In assembly, two ends of the shaft 21 are respectively inserted through the guiding hole 121 of the two guiding blocks 12. The coupling portion 231 is received in the mounting slot 131 of the mounting block 13 and the rotating portion 233 is located on one of the gas slots 133. The main body 31 of the valve assembly 30 is mounted to the mounting block 13 via crews passing through the latching holes 313 and the mounting hole 135. The two coupling boards 33 are located at two sides of the main body 31 and the shaft 21 is enclosed by the openings 331. The two gas valves 35 are mounted to the gas holes 315 and communicate with the gas slots 133. The absorber 40 is located at an end of the shaft 21.

After the rotating mechanism 100 is assembled, the mounting block 13, the main body 31, and the two coupling boards 33 cooperatively form a closed rotating space (not labeled). The rotating block 23 is received in the rotating space. The gas from one of the two gas valves 35 can enter into the rotating space via the gas slots 133 and drives the rotating block 23 to rotate.

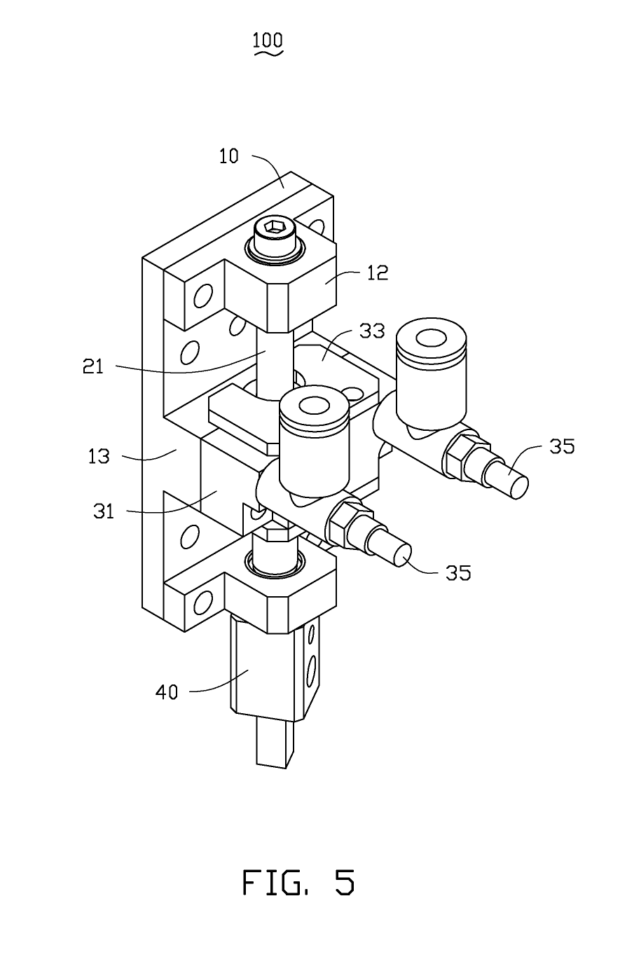

FIG. 5 illustrates an operating state of the rotating mechanism 100. After absorbing a tag, one of the gas valves 35 is opened to let gas coming in. The gas enters into the gas slot 133 via the gas hole 315 and then drives the rotating portion 233 of the rotating block 23 to rotate along a surface of the rotating slot 311. The shaft 21 follows to rotate along a first direction, for example, a clockwise direction. Then, the absorber 40 mounted at an end of the shaft 21 rotates to a predetermined position and the tag absorbed by the absorber 40 is affixed on a first position of the product. The absorber 40 absorbs another tag and the other gas valve 35 is opened to let gas coming in. The gas enters into the other gas slot 133 via the gas hole 315 and then drives the rotating portion 233 of the rotating block 23 to rotate along a surface of the rotating slot 311. The shaft 21 follows to rotate along a reversed direction, for example, an anticlockwise direction. Then, the absorber 40 mounted at an end of the shaft 21 rotates to another position and another tag absorbed by the absorber 40 is affixed on a second position of the product.

In other embodiments, the absorber 40 can be omitted and the shaft 21 can communicate with a gas pipe to absorb tags.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A rotating mechanism comprising:
a holder assembly comprising a mounting block;
a rotating assembly comprising:
a shaft mounted to the holder assembly; and
a rotating block sleeved on the shaft and mounted to the mounting block; and
a valve assembly disposed on the mounting block;
wherein the valve assembly communicates with the mounting block so that gas is capable of coming in to the mounting block to drive the rotating block to rotate and make the shaft rotate.

2. The rotating mechanism of claim 1, wherein the holder assembly further comprises a base board and two guiding blocks, the two guiding blocks are positioned at two opposite ends of the base board, each guiding block defines a guiding hole, two ends of the shaft are inserted through the guiding hole.

3. The rotating mechanism of claim 2, wherein the mounting block is mounted at a middle of the base board and is located between the two guiding blocks, the mounting block defines a mounting slot, the rotating block comprises a coupling portion; the coupling portion is sleeved on the shaft and is received in the mounting slot.

4. The rotating mechanism of claim 3, wherein the rotating block further comprises a rotating portion protruding from a periphery wall of the coupling portion , the mounting slot divides the mounting block into two mounting portions, each mounting portion defines a gas slot, and the rotating portion is located on one of the gas slots.

5. The rotating mechanism of claim 4, wherein the valve assembly comprises a main body, the main body defines a rotating slot, the rotating portion is rotatably received in the rotating slot.

6. The rotating mechanism of claim 5, wherein the rotating slot divides the main body into two latching portions, each latching portion defines a gas hole, the gas hole communicates with the gas slot.

7. The rotating mechanism of claim 6, wherein the valve assembly further comprises two gas valves, each of the two gas valves is mounted to a gas hole.

8. The rotating mechanism of claim 6, wherein each mounting portion further defines a mounting hole, each latching portion further defines a latching hole, and the main body is mounted to the mounting block via the mounting hole and the latching hole.

9. A rotating mechanism comprising:
a holder assembly comprising a mounting block;
a shaft mounted to the holder assembly;
a rotating block sleeved on the shaft and mounted to the mounting block;
an absorber mounted at an end of the shaft and configured to absorb tags; and
a valve assembly disposed on the mounting block;
wherein the valve assembly communicates with the mounting block so that gas is capable of coming in to the mounting block to drive the rotating block to rotate, the shaft and the absorber follow to rotate so as to paste the tags on different positions of a product.

10. The rotating mechanism of claim 9, wherein the holder assembly further comprises a base board and two guiding blocks, the two guiding blocks are positioned at two opposite ends of the base board, each guiding block defines a guiding hole, two ends of the shaft are inserted through the guiding hole.

11. The rotating mechanism of claim 10, wherein the mounting block is mounted at a middle of the base board and is located between the two guiding blocks, the mounting block defines a mounting slot, the rotating block comprises a coupling portion; the coupling portion is sleeved on the shaft and is received in the mounting slot.

12. The rotating mechanism of claim 11, wherein the rotating block further comprises a rotating portion protruding from a periphery wall of the coupling portion, the mounting slot divides the mounting block into two mounting portions, each mounting portion defines a gas slot, and the rotating portion is located on one of the gas slots.

13. The rotating mechanism of claim 12, wherein the valve assembly comprises a main body, the main body defines a rotating slot, the rotating portion is rotatably received in the rotating slot.

14. The rotating mechanism of claim 13, wherein the rotating slot divides the main body into two latching portions, each latching portion defines a gas hole, the gas hole communicates with the gas slot.

15. The rotating mechanism of claim 14, wherein the valve assembly further comprises two gas valves, each of the two gas valves is mounted to a gas hole.

16. The rotating mechanism of claim 14, wherein each mounting portion further defines a mounting hole, each latching portion further defines a latching hole, and the main body is mounted to the mounting block via the mounting hole and the latching hole.

17. A rotating mechanism, comprising:
a rod having a rotating block;
a mounting block rotatably supporting the rod so that the rod can rotate between a first position and a second position, the mounting block having first and second grooves, the rotating block partially blocking the first groove when in the first position and the second groove when in the second position; and
a valve assembly having first and second gas outlet pathways aligned with portions of the first and second grooves, the valve assembly being configured to selectively expel gas through the first and second gas outlet pathways;
wherein when gas is injected by the first and second gas pathways into the first and second grooves, respectively, a gas flow engages the rotating block of the rod to induce rotation of the rod in the mounting block.

18. The rotating mechanism of claim 17, wherein the rotating block is induced to rotate away from the groove that receives injected gas.

19. The rotating mechanism of claim 17, wherein the injected gas enters the first groove where the rod is in the first position, travels the second groove, and emerges there to induce rotation of the rod from the first position toward the second position.

20. The rotating mechanism of claim 17, wherein the injected gas enters the second groove where the rod is in the second position, travels the first groove, and emerges there to induce rotation of the rod from the second position toward the first position.
